(19) United States
(12) Patent Application Publication
(10) Pub. No.: US 2020/0073526 A1
(43) Pub. Date: Mar. 5, 2020

(54) ENERGY MANAGEMENT SYSTEM WITH DRAGGABLE AND NON-DRAGGABLE BUILDING COMPONENT USER INTERFACE ELEMENTS

(71) Applicant: Johnson Controls Technology Company, Auburn Hills, MI (US)

(72) Inventors: Vipul Devre, Kalyan West (IN); Kaustubh S. Patil, Pune (IN); Barkha Shah, Mumbai (IN); Mukul V. Vashisth, Pune (IN)

(73) Assignee: Johnson Controls Technology Company, Auburn Hills, MI (US)

(21) Appl. No.: 16/114,544

(22) Filed: Aug. 28, 2018

(51) Int. Cl. G06F 3/0486; G06F 3/0484; H04L 12/28

(52) U.S. Cl. CPC G06F 3/0486; H04L 12/2816; G06F 3/04847; G06F 3/04842

(57) ABSTRACT

A method includes generating, by a processing circuit, a building component tree for the graphical user interface, wherein the building component tree comprises one or more draggable building components and one or more non-draggable building components and causing, by the processing circuit, the graphical user interface to include the building component tree comprising the draggable building components and the non-draggable building components. The method includes receiving, by the processing circuit via the graphical user interface, a selection of one of the one or more draggable building components and a user interaction dragging the one of the one or more draggable building components into a window of the graphical user interface.

### BACKGROUND

The present disclosure relates generally to heating, ventilation, and air conditioning (HVAC) systems. The present disclosure relates more particularly to an energy management system.

With the advent of advanced building management systems today, it is becoming increasingly viable to monitor a multitude of components within a building to control energy usage of the building. Particularly, an energy management system is type of building management system that focuses on the energy distribution of a building. The energy management system can be a collection of computer-based tools designed to monitor and control energy usage. For a user to monitor and control the system, a user interface is configured to present data on the different elements of system.

### SUMMARY

One implementation of the present disclosure is a method of managing a graphical user interface. The method includes generating, by a processing circuit, a building component tree for the graphical user interface, wherein the building component tree includes one or more draggable building components and one or more non-draggable building components and causing, by the processing circuit, the graphical user interface to include the building component tree including the draggable building components and the non-draggable building components. The method includes receiving, by the processing circuit via the graphical user interface, a selection of one of the one or more draggable building components and a user interaction dragging the one of the one or more draggable building components into a window of the graphical user interface.

In some embodiments, the method further includes operating, by the processing circuit, the one or more pieces of building equipment to control an environmental condition of a building based on at least the selection and the user interaction. In some embodiments, the one of the one or more draggable building components include a component name. In some embodiments, the method further includes causing, by the processing circuit, the component name to change from a first color to a second color to indicate that the draggable building component is draggable in response to receiving the user interaction dragging the one of the one or more draggable building components.

In some embodiments, each of the one or more draggable building components and the one or more non-draggable building components include a rectangular box including a building component name, wherein the building component names of the one or more draggable building components are offset from names of the non-draggable building components, wherein each of the one or more draggable building components include a second rectangular box with edges of a predefined thickness surrounding the rectangular box to indicate draggability of the one or more draggable building components.

In some embodiments, the method further includes causing, by the processing circuit, a cursor to be displayed in the graphical user interface, wherein the cursor is a first cursor type, receiving, by the processing circuit, user input to move the cursor within the graphical user interface, determining, by the processing circuit, whether the user input causes the cursor to be located on the one of the one or more draggable building components, and causing, by the processing circuit, the cursor to change to a second cursor type in response to a determination that the user input causes the cursor to be located on the one of the one or more draggable building components.

In some embodiments, the method further includes causing, by the processing circuit, the graphical user interface to display the one of the one or more draggable components in a first visual style, maintaining, by the processing circuit, the one of the one or more draggable components in the first visual style in response to receiving the user interaction dragging the one of the one or more draggable building components, generating, by the processing circuit, a draggable area for the one or more draggable components, and moving, by the processing circuit, the draggable area of the one of the one or more draggable components within the graphical user interface based on the user interaction dragging the one of the one or more draggable components.

In some embodiments, the method further includes causing, by the processing circuit, a physical user interface of a user device to display the graphical user interface. In some embodiments, receiving, by the processing circuit via the graphical user interface, the selection includes receiving the selection of one of the one or more draggable building components and the user interaction dragging the one of the one or more draggable building components via the physical user interface.

In some embodiments, the building component tree includes the one or more draggable building components and the one or more non-draggable building components ordered in a hierarchy.

In some embodiments, the draggable building components and the non-draggable building components are branches and sub-branches of the hierarchy, wherein the draggable building components and the non-draggable building components include a first building component and a second building component, wherein the first building component is a branch and the second building component is a sub-branch of the branch. In some embodiments, the method further includes causing, by the processing circuit, the graphical user interface to display the first building component, receiving, by the processing circuit, an interaction with the first building component to display any sub-branches of the first building component, and causing, by the processing circuit, the graphical user interface to display the second building component in response to receiving the interaction with the first building component.

In some embodiments, the one or more draggable building components each include a visual draggability indicator indicating that a user can interact with the draggable building component to drag the draggable building component into the window.

In some embodiments, each of the one or more draggable building components includes a component name, wherein the visual draggability indicator includes dots, wherein the dots are located next to the component name.

In some embodiments, the dots are nine dots forming a square.

Another implementation of the present disclosure is a building management system for managing a graphical user interface and operating one or more pieces of building equipment. The system includes a processing circuit configured to generate a building component tree for the graphical user interface, wherein the building component tree includes one or more draggable building components and one or more non-draggable building components, cause the graphical user interface to include the building component tree including the draggable building components and the non-draggable building components, receive, via the graphical user interface, a selection of one of the one or more draggable building components and a user interaction dragging the one of the one or more draggable building components into a window of the graphical user interface, and operate the one or more pieces of building equipment to control an environmental condition of a building based on at least the selection and the user interaction.

In some embodiments, each of the one or more draggable building components and the one or more non-draggable building components include a rectangular box including a building component name, wherein the building component names of the one or more draggable building components are offset from names of the non-draggable building components, wherein each of the one or more draggable building components include a second rectangular box with edges of a predefined thickness surrounding the rectangular box to indicate draggability of the one or more draggable building components.

In some embodiments, the processing circuit is configured to cause the graphical user interface to display the one of the one or more draggable components in a first visual style, maintain the one of the one or more draggable components in the first visual style in response to receiving the user interaction dragging the one of the one or more draggable building components, generate a draggable area for the one or more draggable components, and move the draggable area of the one of the one or more draggable components within the graphical user interface based on the user interaction dragging the one of the one or more draggable components.

In some embodiments, the one or more draggable building components each include a visual draggability indicator indicating that a user can interact with the draggable building component to drag the draggable building component into the window.

In some embodiments, each of the one or more draggable building components includes a component name, wherein the visual draggability indicator includes dots, wherein the dots are located next to the component name.

In some embodiments, the dots are nine dots forming a square.

Another implementation of the present disclosure is a building management system for managing a graphical user interface and operating one or more pieces of building equipment. The system includes one or more pieces of building equipment configured to control an environmental condition of a building. The system includes a processing circuit configured to generate a building component tree for the graphical user interface, wherein the building component tree includes one or more draggable building components and one or more non-draggable building components, wherein the one or more draggable building components each include a visual draggability indicator indicating that a user can interact with the draggable building component to drag the draggable building component into the window. The processing circuit is configured to cause the graphical user interface to include the building component tree including the draggable building components and the non-draggable building components, receive, via the graphical user interface, a selection of one of the one or more draggable building components and a user interaction dragging the one of the one or more draggable building components into a window of the graphical user interface, and operate the one or more pieces of building equipment to control an environmental condition of a building based on at least the selection and the user interaction.

In some embodiments, each of the one or more draggable building components and the one or more non-draggable building components include a rectangular box including a building component name, wherein the building component names of the one or more draggable building components are offset from names of the non-draggable building components, wherein each of the one or more draggable building components include a second rectangular box with edges of a predefined thickness surrounding the rectangular box to indicate draggability of the one or more draggable building components.

In some embodiments, each of the one or more draggable building components includes a component name, wherein the visual draggability indicator includes dots, wherein the dots are located next to the component name.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to an exemplary embodiment.

FIG. 2 is a schematic block diagram of a waterside system that may be used in conjunction with the building of FIG. 1, according to an exemplary embodiment.

FIG. 3 is a schematic block diagram of an airside system that may be used in conjunction with the building of FIG. 1, according to an exemplary embodiment.

FIG. 4 is a schematic block diagram of a BMS which can be used in the building of FIG. 1, according to some embodiments.

FIG. 5 is a schematic block diagram of an energy management system that can be implemented in the BMS controller of FIG. 4, according to an exemplary embodiment.

FIG. 6 is a flow diagram of a process for generating a component tree with draggable and non-draggable components that can be performed by the energy management system of FIG. 5, according to an exemplary embodiment.

FIG. 7 is a flow diagram of a process for displaying draggable components in a user interface window and receiving input from the user interface window that can be performed by the energy management system of FIG. 5, according to an exemplary embodiment.

FIG. 8 is a schematic drawing of a user interface for the energy management system of FIG. 5 that includes a component tree with draggable components and a window into which the draggable components can be dragged, according to an exemplary embodiment.

FIG. 9 is another schematic drawing of the user interface of FIG. 8 that illustrates a user interaction with the draggable components, according to an exemplary embodiment.

FIG. 10 is another schematic drawing of the user interface of FIG. 8 indicating a large draggable area of the window and a draggable area for a draggable component, according to some embodiments.

### DETAILED DESCRIPTION

### Overview

Referring generally to the FIGURES, a building management system is shown, according to various exemplary embodiments. The building management system can be particularly an energy management system that a user can interact with through a user interface. Some embodiments of the present disclosure provide methods and systems for operating one or more pieces of building equipment based on user input via draggable or non-draggable building component elements through a user interface. The user interface can visually indicate whether one (or multiple) of the elements in the component tree is draggable by the user. The inclusion of this feature not only allows the user to drag-drop an item into a window or chart for more detailed viewing or to operate or adjust control algorithms, but also improves usability for the user in the component tree.

A component tree of a building energy management system can include various components, e.g., space components (e.g., zones, buildings, cities, etc.), meter components, equipment components (e.g., thermostats, HVAC equipment, sensors, actuators, etc.), and/or points (e.g., meter readings, set points, temperature values, humidity values, etc. Components of the component tree can be used in an ad hoc and/or custom dashboard to create various charts by drag-dropping them on to a chart canvas. Ad hoc dashboards are described in greater detail in U.S. patent application Ser. No. 15/408,404 filed Jan. 17, 2017, the entirety of which is incorporated by reference herein.

However, not all the components can be drag-dropped on to the chart. Some components may be draggable while other components may not be draggable. Therefore, it may be difficult for the user to identify which components are draggable and which components are not. In this regard, a unique visual indication can be provided in the interface to help the user identify the draggable and/or non-draggable components in combination with a navigation tree.

Lack of visually indicating draggable components in the component tree may make it difficult for the user to identify items which are drag gable from non-draggable items. The systems and methods discussed herein can generate and/or manage a component tree and drag-dropping draggable components. Since the component tree supports this drag-drop feature, a unique visual design can be provided to help the user to distinguish drag gable items from non-drag gable item. The design of the interface can be maintained even when the user drag drops the component in to custom dashboard charts which makes the user aware what is being drag-drop through the process.

Furthermore, the interface can help the user to identify the draggable components, thus saving users valuable time in identifying the draggable components. This interface, due to the component tree, the draggable components, and the visual indication of which components are draggable can result in a user friendly and visually appealing user experience.

In some embodiments, the draggable components include a dotted square formed from one or multiple (e.g., nine dots) on the draggable component (e.g., in the middle, on the left side, on the right side, etc.). In some embodiments, the design of the draggable item is such that even being inside the component tree it does not appear as the part of the component tree which make it visually more appealing. For example, each component can be the same size located in a column with the text of the component indented by predefined amounts to indicate the hierarchy between components. For example, if a first component is a component of a second component (e.g., a thermostat is a component of a building) the text of the first component may be indented by a first predefined amount (e.g., predefined amount more than a current indent of the second component).

Furthermore, for draggable components, the text of the draggable component can be centered within the tree, e.g., shifted to be in the middle of the component. More specifically, the text of the draggable components can be shifted with respect to the text of the non-draggable components, this helps the user identify which components are draggable and which are not. In some embodiments, in response to user interacting with (or all the time, even with no user interaction) the draggable component (e.g., hovering a cursor over the component, clicking on the component, etc.) the text of the draggable component is shifted to be centered within the draggable component if it is normally in an indented position. For example, if the text of the draggable component is indented to the right, in response to a user interacting with the draggable component, the text of the draggable component can be shifted to the left side of the component tree. Furthermore, a rectangle can be created around the draggable component; the rectangle may bold (or a lighter or darker color than a color of the draggable component) the draggable component and may have an inner space where the text of the draggable is located and an outer space surrounding the draggable component. This makes the draggable component bigger than thus easy for the user to drag drop.

Furthermore, when a user interacts with (e.g., navigates over, clicks on, etc.) to the drag gable item, the text of the draggable component (e.g., item name) is changed from a first color to a second color, e.g., from black to white. Furthermore, the user interface element, e.g., cursor, may change from a first cursor type to a second cursor type, e.g., from an arrow to a hand. This indicates user that the item is draggable. Furthermore, when the user tries to drag drop the draggable component, the styling (e.g., text location, bold box, text indent, text color, etc.) of the item is maintained and thus making more visually appealing.

### Building Management System and HVAC System

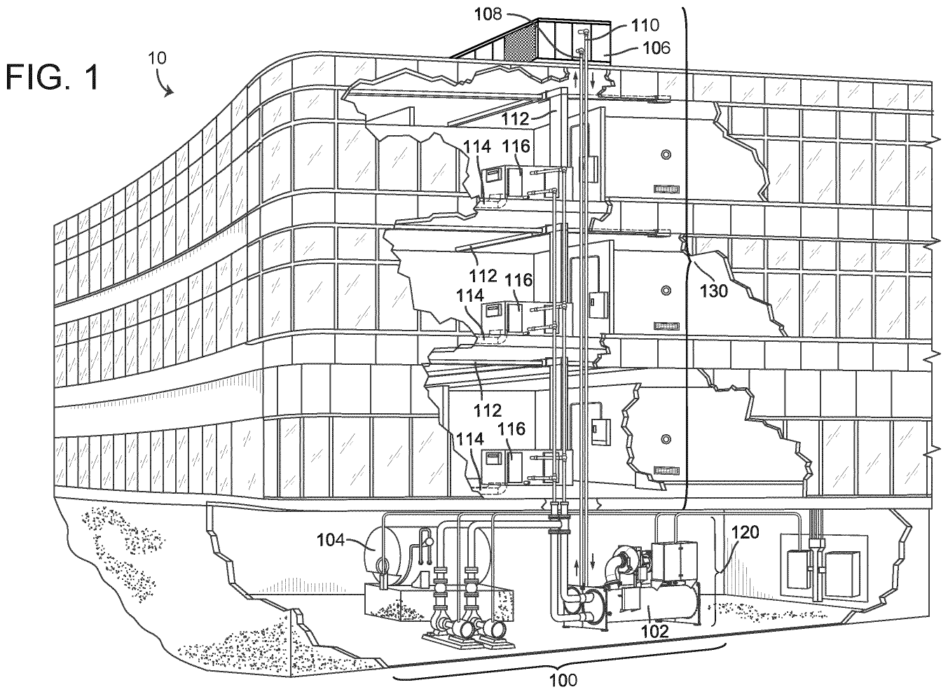

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

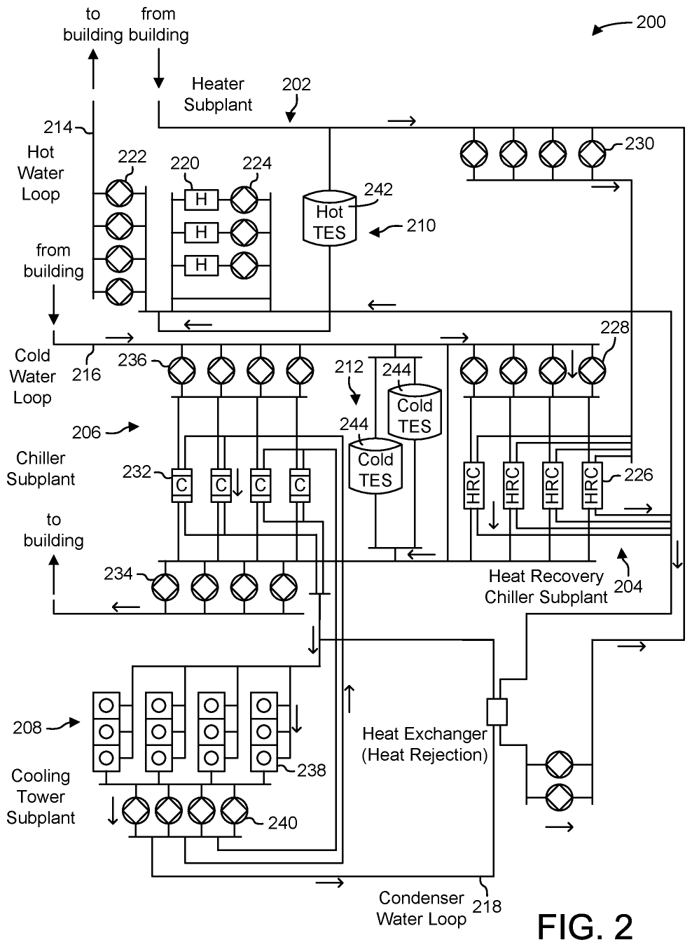

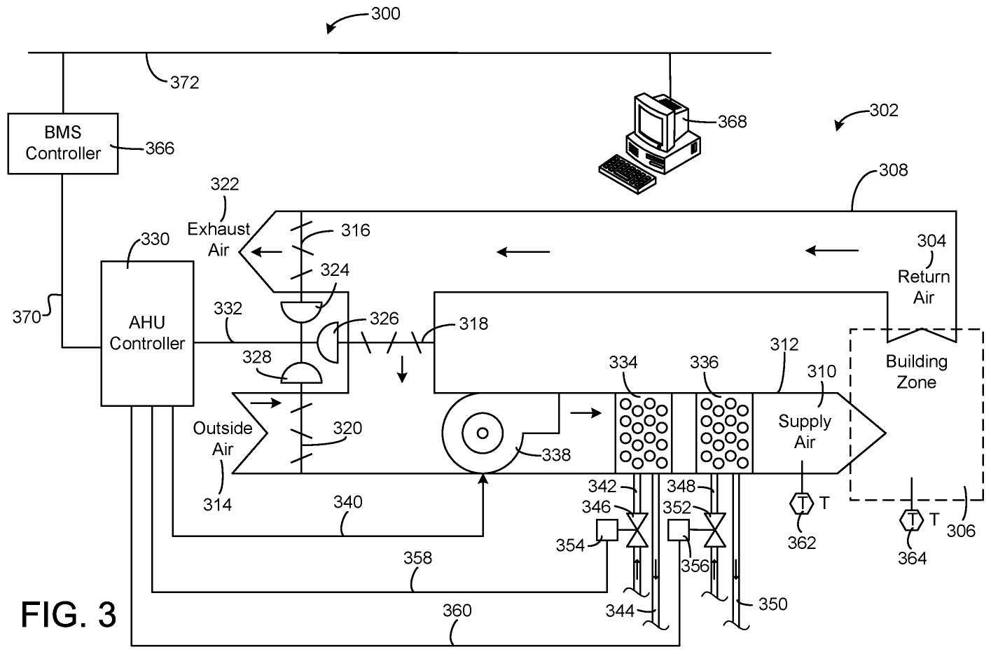

The BMS that serves building 10 includes an HVAC system 100. HVAC system 100 can include HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust air damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, set-points, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

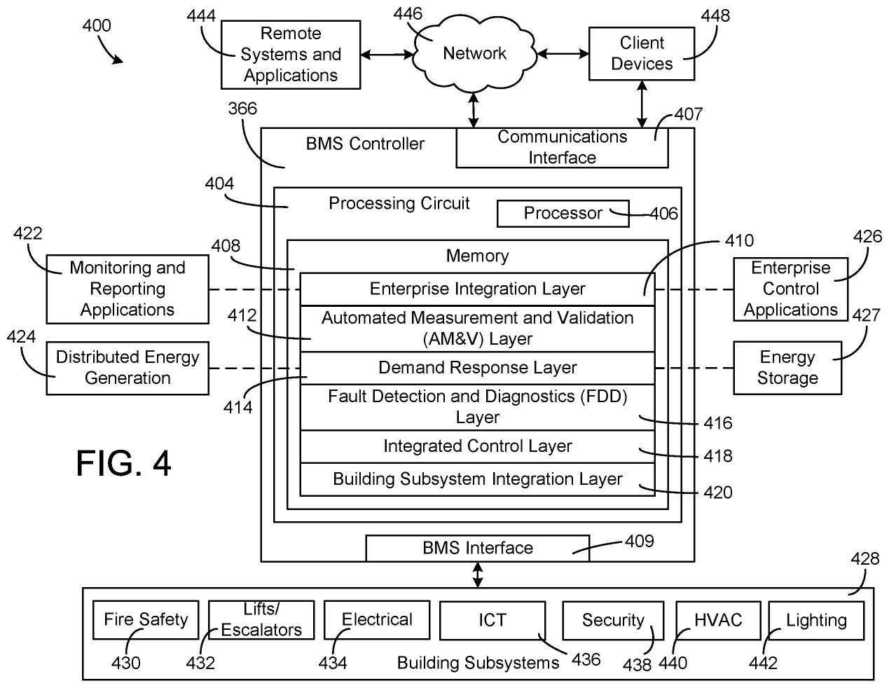

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Energy Management System

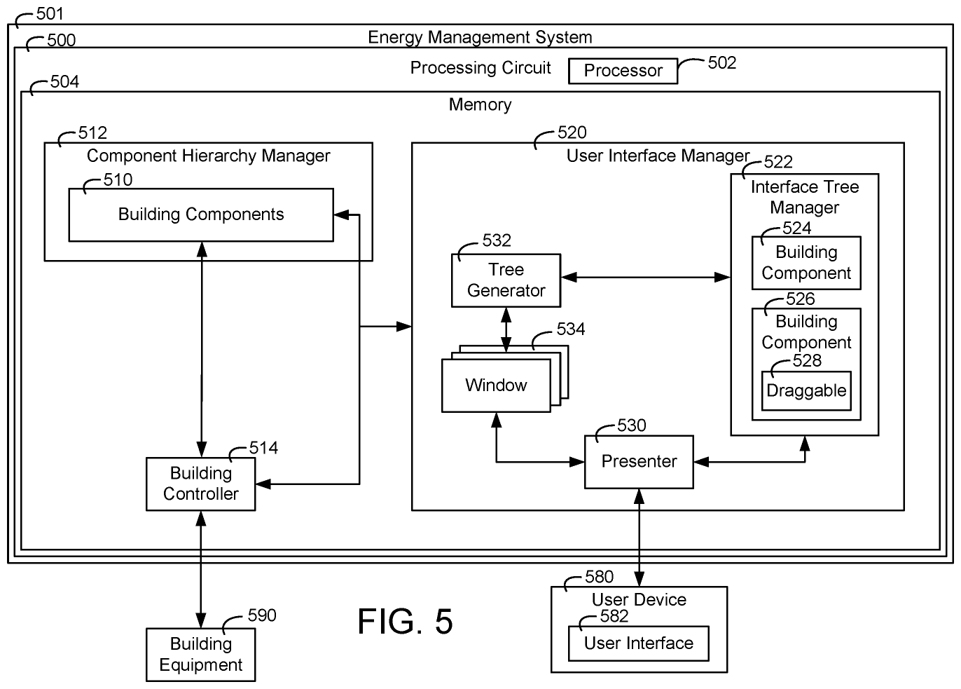

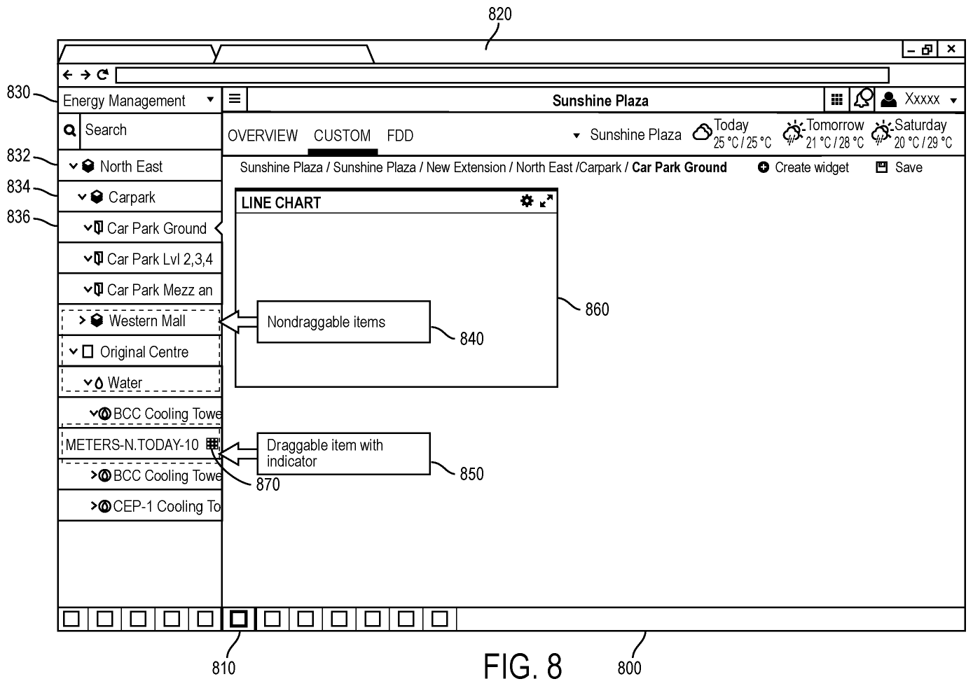

Referring now to FIG. 5, an energy management system 501 is shown for generating a graphical user interface for managing energy resources of a building (e.g., the building 10 as described with reference to FIG. 1), according to an exemplary embodiment. The energy management system 501 may be implemented in the BMS controller 366, the remote systems and applications 444, and/or the client devices 448 of FIG. 4. The energy management system 501 can be configured to generate a graphical user interface, as described in greater detail with further reference to FIGS. 8-10, that can receive user input for controlling various pieces of building equipment and/or building systems to manage energy for a building (e.g., thermostats, controllers, chillers, boilers, energy storage supplants, and/or any of the devices and/or systems as described with reference to FIGS. 1-4). Energy management system 406 is configured to be a subsystem of BMS 400 in some embodiments. For example, energy management system 501 may be a subsystem of BMS 400 configured to analyze data input from a user device 580 and a building equipment 590 to generate information about energy management system 501 for the user.

The energy management system 501 is shown to include a processing circuit 500. The processing circuit 500 includes a processor 502 and a memory 504. The processor 502 can be a general purpose processor, an application specific integrated circuit (ASIC), one or more field programmable gate arrays (FPGAs), a group of processing components, or other suitable electronic processing components. Processing circuit 500 can include a memory 504.

Memory 504 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 504 can be or include volatile memory or non-volatile memory. Memory 504 can include database components, object code components, script components, or any other type of information structure for supporting the various activities and information structures described in the present application. According to an example embodiment, memory 504 is communicably connected to processor 502 via processing circuit 500 and includes computer code for executing one or more processes described herein.

The memory 504 can include a component hierarchy manager 510, a building controller 514, and a user interface manager 520. The component hierarchy manager 510, the building controller 514, and the user interface manager 520 can be configured to operate together to display information on user interface 582 for energy management. The component hierarchy manager 510, the building controller 514, and/or the user interface manager 520 can be configured to operate together by communicating data, instructions, user inputs, and/or user outputs among each. The user interface manager 520 can be configured to receive a hierarchy of building components from the component hierarchy manager 510. The information about different components of the energy management system is obtained through the building controller 514, which is communicably connected to the user interface manager 520.

The component hierarchy manager 510 includes building components 512. According to some embodiments, the building components 512 may be a hierarchical set of elements representing different systems, subsystems, sensors, controllers, and other various components of a building and/or controlled by a building management system (e.g., temperature sensors, humidity sensors, pressure sensors, CO2 probes, HVAC subsystems, security subsystems, etc.). Building components 512 and their location in the hierarchical set may be programmed into the system beforehand.

Building controller 514 is communicably connected to the building equipment 590, in some embodiments. Building controller 514 can be configured to receive input data from sensors, electrical devices, and/or servers that may be included in energy management system 501. The building controller 514 may be responsible for some or all of the information provided to the presenter 530. Building controller 514 may be communicably connected to building equipment 590 to receive input data from building 10. Using this data, building controller 514 may configure a hierarchy of building components 512 and generate a component tree to present to presenter 530.

Building controller 514 may be able to adjust the building management system based on the user interaction with the draggable components. For example, based on draggable components that a user drags into a canvas and/or into another location within the component tree (e.g., as shown in greater detail FIGS. 8-10) one or multiple control algorithms can be updated and/or executed by the building controller 514 to control physical conditions (e.g., temperature, humidity, air quality, air flow, damper position, etc.). The building controller 514 can perform some and/or all of the control algorithms described with reference to FIG. 4 (e.g., optimization algorithms, PID algorithms, etc.).

For example, if a temperature sensor component is located under a first zone component (e.g., a representation that a sensor measures the temperature of the first zone) but a user drags the sensor to be under a second zone component, this may indicated that equipment of the second zone should be operated based on temperature measurements of the sensor. This dragging of a sensor component could be performed in response to the sensor being physically removed from the first zone and installed in the second zone. Based on these changes the building controller 514 can adapt control algorithms to the current hierarch.

User interface 582 may show control elements in the window 534 that can alter the energy usage of building 10. For example, a user drags draggable component 526 to a chart for inspection, wherein draggable component 526 represents the HVAC system of building 10. Inconsistencies are shown in the chart with regards to temperature at a specific location in building 10. An icon configured to be clicked on by a user is available in the window 534 that, when clicked on, would alter the energy usage of the heaters and chillers of building 10 to obtain an ideal temperature. This alteration may be a decrease in power sent to the chillers to increase in temperature.

The user interface manager 520 can be configured to provide information regarding draggable and/or non-draggable components and the information about the building systems represented by the components to a graphical user interface. In some embodiments, the user interface manager 520 is shown to include interface tree manager 522, tree generator 532, window 534, and presenter 530.

The interface tree manager 522 is configured to compile information about draggable and non-draggable components and assign each building component to their respective draggability label in some embodiments. In some embodiments, the interface tree manager 522 is configured to input data from the tree generator 532, the data including information about the hierarchy of building components 510. Interface tree manager 522 is also communicably connected to the presenter 530, wherein the interface tree manager 522 outputs information about the draggable components to the presenter 530. For example, building component 526 is assigned draggable label 528 in the interface tree manager 522. The component is structured into the hierarchy of building components 510 assembled by tree generator 532 and the total information is sent to presenter 530 for user interfacing.

Tree generator 532 is configured to generate a component tree based on information provided about the building energy usage and the building component hierarchy in some embodiments. In some embodiments, tree generator 532 receives this information from building controller 514 and component hierarchy manager 510. An example of this can be shown as an HVAC system being presented to a user. Sensor data from the HVAC devices (e.g., heaters, chillers, pumps, fans, etc.) and the multiple building components are sent to building controller 514. Building controller 514 may analyze the data to construct a hierarchy for the HVAC system and output the information to tree generator 532. Tree generator 532 may then generate a component tree configured for window 534.

Another example can be shown as the component hierarchy manager 510 constructing a hierarchy tree and outputting the information to tree generator 532, while building controller 514 collects and analyzes information from the monitoring devices and outputs the information to tree generator 532. Tree generator 532 may then generate a component tree configured for window 534. Trees generated by tree generator 532 may be a pop-up tree in either a horizontal or vertical configuration. A pop-up tree may be any tree that reveals lower branches to the user as the user interacts with the high-level branches. This process continues, as a user may interact with sub-branches to reveal the respective lower branches.

Presenter 530 is configured to be a module that is used to compile the various components needed for user interfacing and present them on the user interface. The presenter 530 may be any system including of a control element in a graphical user interface that displays the component tree and the various components included therein.

Window 534 provide a clear and efficient way for a user interface to represent both a component tree and a collection of charts configured to present data from the draggable components. In some embodiments, a user interacts with the visually-indicated draggable element to move the element across a screen, where the user would then drop the element into a chart. The chart, configured to present data from the draggable components, would present the data corresponding to the element the user dragged into the chart. The tree generator 532 can be configured to generate a component tree.

The building components 512, draggability indicators, and component tree can be configured inside of window 534. In various other embodiments, a chart may be included inside of the window, or placed in a separate window. For example, a temperature sensor configured to monitor a portion of HVAC subsystem 440 may send temperature data to the building controller 514. Building controller 514 may compile, analyze, and output the data to the interface tree manager 522 for draggability labeling. Graphs, charts, trees, and other control elements that users interact with are typically shown to the user in another control element intended for enclosing widgets, wherein this enclosing control element can be window 534.

In some embodiments, the collection of components responsible for providing information regarding draggable and non-draggable components and the information about the building systems represented by the components to a user interface (i.e., the user interface manager 520) may vary in quantity. For example, the presenter 530 and window 534 may be combined into a single component responsible for showing information through user interface 582. An example of these carious components operating together follows: user requests information on temperature measurements over a period of time inside of a given building. The tree generator 532 may generate a tree of hierarchical building components inside of window 534. Building controller 514 may send data on temperature fluctuations of the building to the interface tree manager 522. According to building controller 514, temperature fluctuations is an element found inside of fire safety subsystem 430 outlined in FIG. 4. Interface tree manager 522 will then configure a building component 524 to be fire safety subsystem 430 and assign it to be non-draggable. It will also configure building component 526 to be temperature fluctuations and assign it a draggable label 528. Presenter 530 receives these now-labeled components and presents them in the generated component tree to the user.

The presenter 530 can be configured to present the components with different visual indicators based on whether the components are draggable or non-draggable and/or whether a user is interacting with (e.g., has hovered over, clicked on, and/or dragged). For example, for the building component 524, the building component 524 can be displayed as a rectangle with a name inside the rectangle. However, the building component 526 can also be displayed as a rectangle with a name inside the rectangle but the text of the name can be offset from the text of the building component 524 (e.g., offset by a predefined amount, e.g., to the left or right of the text of the building component 524).

Furthermore, the building component 526 can include a visual indicator icon that indicates that the building component 526 is draggable. The indicator can be an icon, text (e.g., “Draggable”) or one or more dots. The dots can be organized in a particular shape, e.g., square, circle, rectangle, etc.

Furthermore, the building component 526 can be displayed via the presenter 530 as a rectangle with a second rectangle surrounding the rectangle. In this regard, for draggable components, when a user interacts with (e.g., hovers over with a cursor) (or without interaction), the second rectangle can be generated to cause a user to easily see that the component is draggable. The first rectangle may be smaller and include both the indicator icon and component name text while the second rectangle may surround the first rectangle creating a space between the first rectangle and the second rectangle. Furthermore, in response to interaction, the presenter 530 can cause the color of the component name to change. For example, the color could change from grey to white or white to red.

Furthermore, in response to a user dragging a draggable component, e.g., the component 526, the presenter 530 can cause the draggable component to remain in its current visual state (e.g., with a box surrounding it, in a particular color, etc.). The presenter 530 can generate a draggable area, e.g., the same size as the rectangle of the building component 526, and allow the user to drag the draggable area around the interface.

In some embodiments, user device 580 and building equipment 590 are communicably connected to energy management system 501. The connection between these elements can be or include wired or wireless communications interfaces (e.g., jacks, antennas, transmitters, receivers, transceivers, wire terminals, etc.). In various embodiments, communications can be direct (e.g., local wired or wireless communications) or via a communications network (e.g., a WAN, a LAN, the Internet, a cellular network, etc.).

User device 580 can be configured to be the hardware component used by the user for interacting with the user interface 582. In this regard, the user device may be any device capable of allowing a user to interact with the user interface 582. This includes but is not limited to, a computer workstation a cellphone, a laptop, a desktop commuter, a tablet, and wearable computers (e.g., smartwatches, smart glasses, etc.) and various other computer devices. In some embodiments, the user device includes a screen and a communicable connection with the energy management system 501 through user interface 582.

User interface 582 is configured to be the interface by which the user and a computer system interact. The term “user interface” can refer to a graphical interface or a physical interface by which a user and a computer system interact. The user interface can be a touch screen interface, a text base interface, and/or a graphical user interface (e.g., a WIMP (Windows, Icons, Menus, and Pointers) interface). In some embodiments, user interface 582 can be a physical element that displays a graphical user interface. A pointer used in this regard may be any onscreen symbol that represents movement of a physical device that the user controls. It can be used to select icons, data elements, building component 524, building component 526, etc.

An icon used in this regard may be any item on the user interface that acts as a shortcut to an action that the computer performs. In some embodiments, the user interface includes control elements that aid in usability and visibility for the user. The control elements are configured to allow a user to monitor the different energy components of energy management system 501, wherein the control elements can be component trees, drag-drop windows, buttons, scroll bars and visually-indicating icons, and various other widgets. User device 580 can include a network interface that can be or include wired or wireless communications interfaces (e.g., jacks antennas, transmitters, receivers, transceivers, wire terminals, etc.) for conducting data communications with energy management system 501.

Building equipment 590 is configured to be one or more elements of the energy management system 501 that is outputting data to the controller in some embodiments. In some embodiments, building equipment 590 includes the sensors, and electrical devices monitoring energy usage throughout building 10. In various other embodiments, building equipment 590 can include the entity of that which is being monitored. For example, HVAC building subsystem 440 is communicably coupled to BMS controller 366 through BMS Interface 409. HVAC building subsystem 440 can include sensors and electrical devices outputting data to BMS controller 366. HVAC building subsystem 440 can also include multiple HVAC devices (e.g., heaters, chillers, air handling units, pumps, fans, thermal energy storage, etc.) that may or may not be monitored by the sensors and electrical devices. Both the HVAC devices and monitoring devices can be included in building equipment 590.

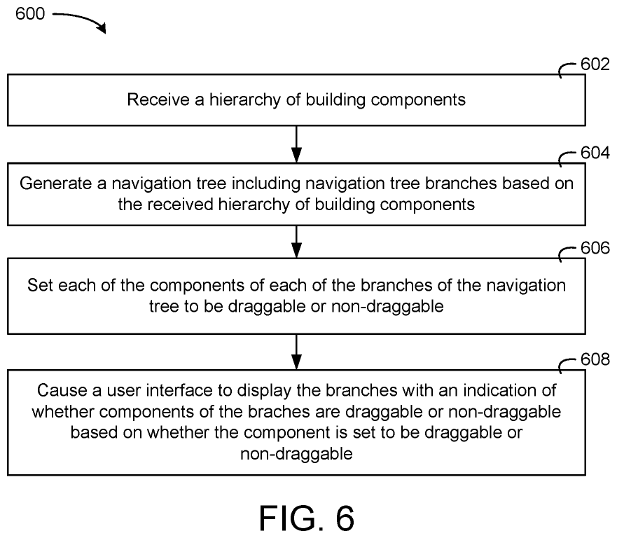

Referring now to FIG. 6, a process 600 is shown for operating one or more pieces of building equipment based on user input via draggable or non-draggable building components of a user interface, according to an exemplary embodiment. The energy management system 501 can be configured to perform the process 600. Furthermore, the user device 580, the BMS controller 366, and/or any other computing device as described herein can be configured to perform the process 600.

In step 602, the user interface manager 520 receives a hierarchy of building components. In some embodiments, hierarchy of building components is received from the component hierarchy manager 510 and sent to the user interface manager 520. A hierarchy of building components may include the different building systems and/or subsystems. For example, a hierarchy of building components may include an HVAC system and its respective subsystems (e.g., heating subsystem, cooling subsystem, roof top units (RTUs), etc.). Including multiple derivations and scopes of the building systems allows the user interface 582 to display information more tailored to the preferences of the user. The component hierarchy manager 510 may generate the hierarchy of building components based on a metric of importance with regard to the building systems. In some embodiments, component hierarchy manager 510 can create a hierarchy of building components where the hierarchical aspects are determined by the energy usage of certain systems in building 10. For example, lighting system 442 in building 10 may dissipate 30% of the building's energy usage. As this is a significant portion of the building's energy usage, component hierarchy manager 510 generate a more detailed component hierarchy tree that includes the lighting subsystems for each floor. Components of the component hierarchy tree may be programmed in, or generated automatically based on an algorithm (e.g., systems/subsystems that dissipate more than 5% of the energy usage in the building). In some instances, the component hierarchy tree 510 may change only when it is programmed to do so, or it may change automatically based on a continuous algorithm. Since the building components 512 may be generated in different locations of the component hierarchy tree over a period of time, building controller 514 may input data from all or the sensors, controllers, servers and other electrical devices included in all of the systems and subsystems of building 10.

In step 604, the user interface manager 520 generates a component tree wherein the component tree includes tree branches based on the received hierarchy. In some embodiments, tree generator 532 generates the component tree. Component trees may be configured in multiple ways, including a pop-up horizontal component tree, a pop-up vertical component tree, and/or a vertical component tree. A pop-up tree may be any tree that reveals lower branches to the user as the user interacts with the high-level branches. For example, a component tree may begin only showing the highest tree component (e.g., an energy management system). When a user clicks on the highest tree component, the branches of the tree may be shown. This process can continue, as a user may interact with branches and sub-branches to reveal their respective lower branches. A pop-up vertical component tree can expand and contract its branches in a vertical direction, whereas a pop-up horizontal component tree can expand and contract its branches in a horizontal direction. Building components may include the different building systems and/or subsystems in building 10. Outlined in FIG. 8-10, a vertical component tree is shown, wherein it lists the branches of the component tree and sub-branches (leaves) in a vertical hierarchy wherein the branches and leaves are configured to be expanded and collapsed.

In step 606, user interface manager 520 sets each of the components of each of the branches of the component tree to be draggable or non-draggable. In some embodiments, this is done in interface tree manager 522, wherein interface tree manager 522 labels which components are to be draggable and non-draggable (e.g., building component 524 and building component 526), and sends the labeled components to presenter 530. The component tree may be configured in tree generator 532, wherein a component tree is generated based on input from building controller 514 and allows presenter 530 to outline components from interface tree manager in the correct hierarchical way for the user.

In step 608, user interface manager 520 causes a user interface to display the branches with an indication of whether components of the branches are draggable or non-draggable based on whether the component is set to be draggable or non-draggable. In some embodiments, the presenter 530 causes the user interface 582 to display the interface tree with the draggable and non-draggable components. The presenter 530 may be any system including of a control element in a graphical user interface that displays the component tree and the various components included therein. For example, FIG. 5 shows control element window 534 displaying information of a component tree, generated from tree generator 532. The draggable and non-draggable components have been presented to the presenter 530 through the interface tree manager 522.

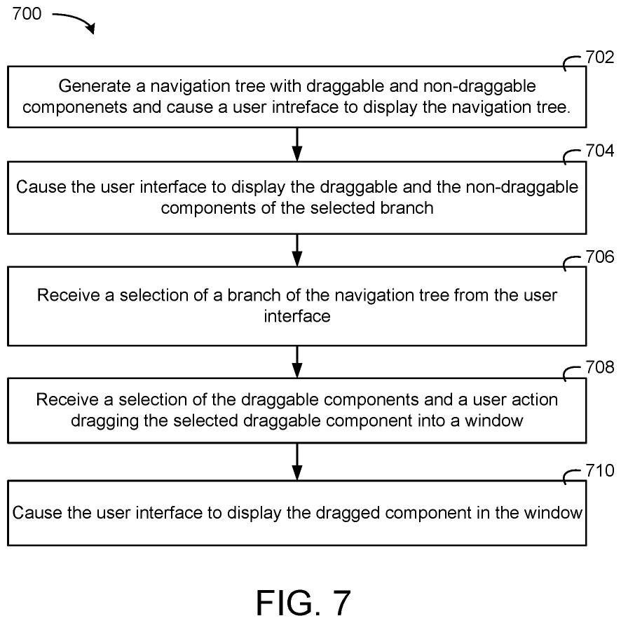

Referring now to FIG. 7, a process 700 is shown for displaying draggable components in a window with input from a user interface, according to an exemplary embodiment. In some embodiments, draggable component 526 can be displayed on presenter 530 through user interface 582. The energy management system 501 can be configured to perform the process 700. Furthermore, the user device 580, the BMS controller 366, and/or any other computing device as described herein can be configured to perform the process 700.

In step 702, the user interface manager 520 generates a component tree with draggable and non-draggable components and causes a user interface to display the component tree. Step 702 may be the same and/or similar to the steps 602-606 of process 600 as described with reference to FIG. 6 where a hierarchy of building components is received, a component tree is generated based on the hierarchy provided, components of the branches are set to be draggable or non-draggable, and a user interface is caused to display such branches with visual indicators of their draggability. For example, component hierarchy manager 510 sends user interface manager 520 the hierarchy of building components. Tree generator 532 then generates a component tree. Interface tree manager 522 then labels which components are to be draggable and non-draggable, and sends the labeled components to presenter 530. Control element window 534 displays information of a component tree, generated from tree generator 532.

In step 704, the user interface manager 520 causes the user interface 582 to display the draggable and the non-draggable components of the selected branch. In step 704, presenter 530 causes the user interface to display the draggable and the non-draggable components of the selected branch. In some embodiments, presenter 530 connects to the graphical user interface of user interface 582 to display the components and their draggability, as determined by the interface tree manager 522.

In step 706, the user interface manager 520 receives a selection of a branch of the component tree from the user interface. The graphical user interface of user interface 582 may be communicably connected to the presenter 530. From this, a user may choose a branch from the component tree to be analyzed. Users typically interact with a user interface by clicking on interface elements that are shown. In this particular embodiment, component tree 830 and chart window 860 are examples of interface elements herein.

In step 708, the user interface manager 520 receives a selection of the draggable components and a user action dragging the selected draggable component into a window. When a user chooses a draggable component, presenter 530 maintains the unique styling and indication of the draggable component, as outlined in FIGS. 8-10. The draggable indicator icon 870 and unique styling of the draggable component, branch 838 exemplify this.

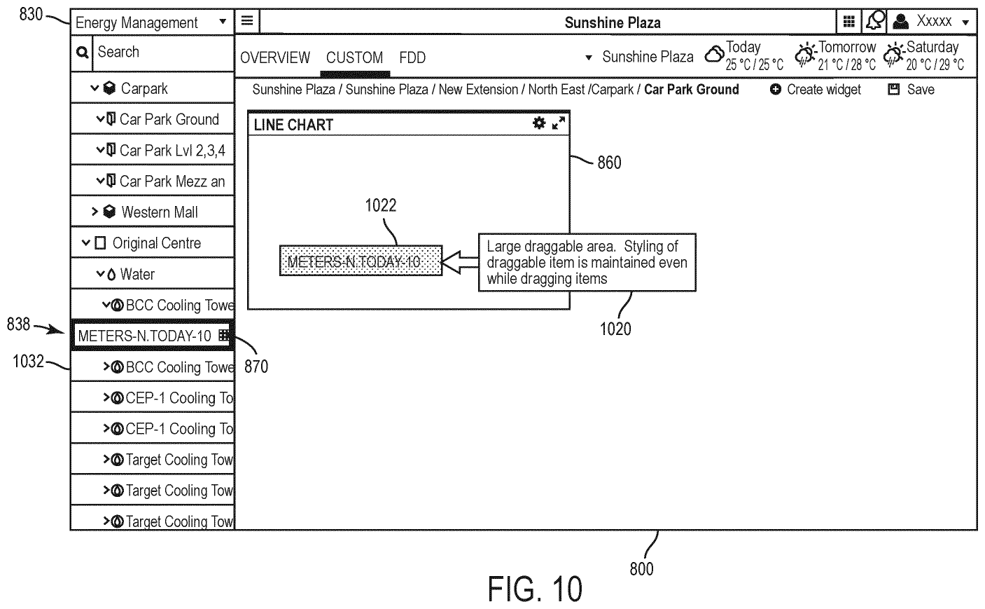

In step 710, the user interface manager 520 causes the user interface to display the dragged component in the window. When a user drags a draggable component into a window chart, the unique styling of the draggable item is maintained upon dragging, as outlined in FIG. 10. In this embodiment, branch 838 is being dragged by a user and dropped into window chart 860.

Referring now to FIGS. 8-10, a user interface 800 is shown, wherein web browser 810 is showing web page 820. In this arrangement, a web browser can be configured to be any software application used for accessing the network for the BMS. This includes, but it not limited to, the World Wide Web. Web page 820 is shown to include a component tree 830, a chart 860 and the various components included therein. For this embodiment, web page 820 is displaying, among other images, widgets and documents, digital energy management system 501.

Still referring to FIGS. 8-10, user interface 800 is shown to include component tree 830. The system 501 can be configured to generate, receive input for, and manage the user interface 800. Component tree 830 is shown to include several branches and leaves for the respective branches. In this embodiment, component tree 830 is a control element that a user is able to interact with through user interface 582. For example, branch 832 is configured to be the component for the North East portion of the energy management system 501. A user may click on the branch 832 to drop-down the branch into its leaves, exemplified by leaf 834. This process may continue for the sub-leaves of leaves, shown by sub-leaf 836. In some embodiments, certain components (e.g., branches, sub-branches, leaves, etc.) of component tree 830 may be draggable. Draggable items in component tree 830 may have a unique design, both in size of component item and style of text. For example, draggable time 850 in component tree 830 has increased in size and shifted the component name off-center (e.g., to the left of non-draggable components). These indicators make draggable item 850 larger (or easier to see) and unique, making drag-dropping components easier for the user.

Referring particularly to FIG. 8, indicators are added to show uniqueness of the tree elements. Indicator of non-draggable items 840 points to tree branches that are non-draggable, as determined by interface tree manager 522 outlined in FIG. 5. Indicator of draggable items 850 points to the tree branch 838, wherein tree branch 838 is configured to be draggable. The draggable component is visually-indicated to the user through the use of an icon, shown as the draggable indicator icon 870. For this particular representation, a visual indicator to the user presented on the user interface may include but is not limited to, icons, images, symbols, pictures, and figures. In some embodiments, draggable indicator icon 870 is shown to consist of a dotted square formed by nine dots on the right side of the draggable item.

The icon 870 can be one or more dots (e.g., with a solid fill or an outline) organized into a square. In some embodiments, the icon 870 includes four dots. In some embodiments, the icon 870 includes nine dots. In various embodiments, any type of shape (e.g., triangle, square, rectangle, hexagon, octagon, etc.) can be formed with any number of dots.

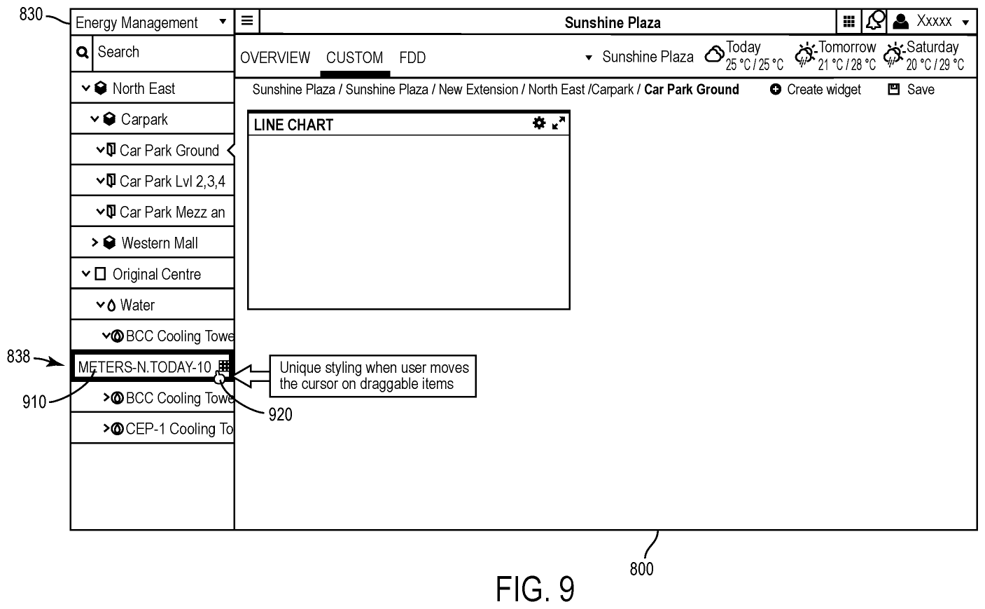

Referring particularly to FIG. 9, an additional indicator is added to the graphical user interface of user interface 582. When a user hovers over (with a cursor), or otherwise interacts with a draggable component, a unique styling is shown. In this exemplified embodiment, a hand symbol 920 is shown and the branch 838 are shown to be bolded with an external rectangle and/or the text of the component is changed to a particular font, so as to visually indicate this distinction between draggable branch 838 and non-draggable components. In some embodiments, hand symbol 920 can be the symbol shown on a cursor/pointer when the cursor/pointer hovers over a component that is draggable, indicating to the user that the component is draggable. For this particular representation, a unique styling for visual indication presented on the user interface may include but is not limited to, font size, font type, font outline, highlighting, bolding, italicizing, and underlining. In some embodiments, branch 838 is shown to consist of a bolded white component name in all capitals.

Referring particularly to FIG. 10, indicator 1020 shows unique styling of draggable item is maintained even upon dragging. In some embodiments, user interface 800 is shown to include the menu tree 830. Menu tree 830 includes of multiple branches and leaves, some of which are configured to be draggable, indicated with the draggable indicator icon 870. In particular, branch 838 is shown to be draggable. For this embodiment outlined in FIG. 10, a user drags branch 838 over to the chart window 860. Indicator 1020 shows the unique styling of branch 838 is maintained even upon dragging, making the user aware of what is being dragged and dropped throughout the process of dragging and dropping a component. The unique styling is a bolded white font in all capitals of the component name, for this example.

A draggable area 1022 is shown in the interface 800. The draggable area 1022 can be generated by the system 501 in response to a user selecting and dragging a draggable component, e.g., the branch 838. In this regard, the unique styling (e.g., the dots of icon 870, and the bold box surrounding the branch 838) can be retained in the interface 800 while the user drags the draggable area 1022 around the interface 800. In this regard, in response to a user selecting the branch 838, the system 501 can generate the draggable area 1022 and allow the user to move the draggable area 1022 around the screen. This allows the unique styling of draggable components to be included within the interface 800 even while a user is dragging the component.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A method of managing a graphical user interface, the method comprising:
generating, by a processing circuit, a building component tree for the graphical user interface, wherein the building component tree comprises one or more draggable building components and one or more non-draggable building components;
causing, by the processing circuit, the graphical user interface to include the building component tree comprising the one or more draggable building components and the one or more non-draggable building components; and
receiving, by the processing circuit via the graphical user interface, a selection of one of the one or more draggable building components and a user interaction dragging the one of the one or more draggable building components into a window of the graphical user interface.

2. The method of claim 1, further comprising operating, by the processing circuit, one or more pieces of building equipment to control an environmental condition of a building based on at least the selection and the user interaction;
wherein the one of the one or more draggable building components comprises a component name;
wherein the method further comprises causing, by the processing circuit, the component name to change from a first color to a second color to indicate that the draggable building component is draggable in response to receiving the user interaction dragging the one of the one or more draggable building components.

3. The method of claim 1, wherein each of the one or more draggable building components and the one or more non-draggable building components comprise a rectangular box comprising a building component name, wherein the building component names of the one or more draggable building components are offset from names of the non-draggable building components, wherein each of the one or more draggable building components comprise a second rectangular box with edges of a predefined thickness surrounding the rectangular box to indicate draggability of the one or more draggable building components.

4. The method of claim 1, wherein the method further comprises:
causing, by the processing circuit, a cursor to be displayed in the graphical user interface, wherein the cursor is a first cursor type;
receiving, by the processing circuit, user input to move the cursor within the graphical user interface;
determining, by the processing circuit, whether the user input causes the cursor to be located on the one of the one or more draggable building components; and
causing, by the processing circuit, the cursor to change to a second cursor type in response to a determination that the user input causes the cursor to be located on the one of the one or more draggable building components.

5. The method of claim 1, wherein the method further comprises:
causing, by the processing circuit, the graphical user interface to display the one of the one or more draggable components in a first visual style;
maintaining, by the processing circuit, the one of the one or more draggable components in the first visual style in response to receiving the user interaction dragging the one of the one or more draggable building components;
generating, by the processing circuit, a draggable area for the one or more draggable components; and
moving, by the processing circuit, the draggable area of the one of the one or more draggable components within the graphical user interface based on the user interaction dragging the one of the one or more draggable components.

6. The method of claim 1, wherein the method further comprises causing, by the processing circuit, a physical user interface of a user device to display the graphical user interface;
wherein receiving, by the processing circuit via the graphical user interface, the selection comprises receiving the selection of one of the one or more draggable building components and the user interaction dragging the one of the one or more draggable building components via the physical user interface.

7. The method of claim 1, wherein the building component tree comprises the one or more draggable building components and the one or more non-draggable building components ordered in a hierarchy.

8. The method of claim 7, wherein the one or more draggable building components and the one or more non-draggable building components are branches and sub-branches of the hierarchy, wherein the one or more draggable building components and the one or more non-draggable building components comprise a first building component and a second building component, wherein the first building component is a branch and the second building component is a sub-branch of the branch;
wherein the method further comprises:
causing, by the processing circuit, the graphical user interface to display the first building component;
receiving, by the processing circuit, an interaction with the first building component to display any sub-branches of the first building component; and
causing, by the processing circuit, the graphical user interface to display the second building component in response to receiving the interaction with the first building component.

9. The method of claim 1, wherein the one or more draggable building components each comprise a visual draggability indicator indicating that a user can interact with the draggable building component to drag the draggable building component into the window.

10. The method of claim 9, wherein each of the one or more draggable building components comprise a component name, wherein the visual draggability indicator comprises a plurality of dots, wherein the plurality of dots are located next to the component name.

11. The method of claim 10, wherein the plurality of dots are nine dots forming a square.

12. A building management system for managing a graphical user interface and operating one or more pieces of building equipment, the system comprising a processing circuit configured to:
generate a building component tree for the graphical user interface, wherein the building component tree comprises one or more draggable building components and one or more non-draggable building components;
cause the graphical user interface to include the building component tree comprising the one or more draggable building components and the one or more non-draggable building components;
receive, via the graphical user interface, a selection of one of the one or more draggable building components and a user interaction dragging the one of the one or more draggable building components into a window of the graphical user interface; and
operate the one or more pieces of building equipment to control an environmental condition of a building based on at least the selection and the user interaction.

13. The system of claim 12, wherein each of the one or more draggable building components and the one or more non-draggable building components comprise a rectangular box comprising a building component name, wherein the building component names of the one or more draggable building components are offset from names of the one or more non-draggable building components, wherein each of the one or more draggable building components comprise a second rectangular box with edges of a predefined thickness surrounding the rectangular box to indicate draggability of the one or more draggable building components.

14. The system of claim 12, wherein the processing circuit is configured to:
cause the graphical user interface to display the one of the one or more draggable components in a first visual style;
maintain the one of the one or more draggable components in the first visual style in response to receiving the user interaction dragging the one of the one or more draggable building components;
generate a draggable area for the one or more draggable components; and
move the draggable area of the one of the one or more draggable components within the graphical user interface based on the user interaction dragging the one of the one or more draggable components.

15. The system of claim 12, wherein the one or more draggable building components each comprise a visual draggability indicator indicating that a user can interact with the draggable building component to drag the draggable building component into the window.

16. The system of claim 15, wherein each of the one or more draggable building components comprise a component name, wherein the visual draggability indicator comprises a plurality of dots, wherein the plurality of dots are located next to the component name.

17. The system of claim 16, wherein the plurality of dots are nine dots forming a square.

18. A building management system for managing a graphical user interface and operating one or more pieces of building equipment, the system comprising:
one or more pieces of building equipment configured to control an environmental condition of a building; and
a processing circuit configured to:
generate a building component tree for the graphical user interface, wherein the building component tree comprises one or more draggable building components and one or more non-draggable building components, wherein the one or more draggable building components each comprise a visual draggability indicator indicating that a user can interact with the draggable building component to drag the draggable building component into the window;
cause the graphical user interface to include the building component tree comprising the one or more draggable building components and the one or more non-draggable building components;
receive, via the graphical user interface, a selection of one of the one or more draggable building components and a user interaction dragging the one of the one or more draggable building components into a window of the graphical user interface; and
operate the one or more pieces of building equipment to control an environmental condition of a building based on at least the selection and the user interaction.

19. The system of claim 18, wherein each of the one or more draggable building components and the one or more non-draggable building components comprise a rectangular box comprising a building component name, wherein the building component names of the one or more draggable building components are offset from names of the one or more non-draggable building components, wherein each of the one or more draggable building components comprise a second rectangular box with edges of a predefined thickness surrounding the rectangular box to indicate draggability of the one or more draggable building components.

20. The system of claim 18, wherein each of the one or more draggable building components comprise a component name, wherein the visual draggability indicator comprises a plurality of dots, wherein the plurality of dots are located next to the component name.
